(19) United States
(12) Patent Application Publication
(10) Pub. No.: US 2026/0100184 A1
(43) Pub. Date: Apr. 9, 2026

(54) SPOKEN LANGUAGE UNDERSTANDING SYSTEM AND A METHOD FOR TRAINING THE SAME

(71) Applicant: VINAI ARTIFICIAL INTELLIGENCE APPLICATION AND RESEARCH JOINT STOCK COMPANY, Ha Noi (VN)

(72) Inventors: Quoc Dat Nguyen, Ha Noi (VN); Hoai Phu Thinh Pham, Ha Noi (VN); Bao Chi Tran, Ha Noi (VN); Hai Hung Bui, Ha Noi (VN)

(73) Assignee: VINAI ARTIFICIAL INTELLIGENCE APPLICATION AND RESEARCH JOINT STOCK COMPANY, Ha Noi (VN)

(21) Appl. No.: 18/950,969

(22) Filed: Nov. 18, 2024

(30) Foreign Application Priority Data
Oct. 8, 2024 (VN) 1-2024-07553

(51) Int. Cl. G10L 15/06; G10L 15/22

(52) U.S. Cl. CPC G10L 15/063; G10L 15/22

(57) ABSTRACT

This disclosure relates to a spoken language understanding (SLU) system and method for training the same. The method comprises: generating a vector eᵢ to represent an i^{th} word token wᵢ based on n word tokens; generating an intent-specific matrix E^{I} and a slot-specific matrix E^{S} based on a sequence of vectors e_{1:n}; generating an intent label-specific matrix V^{I} and slot label-specific matrices V^{S,K} based on the intent-specific matrix E^{I} and the slot-specific matrix E^{S}, respectively; generating a multiple intent representing matrix [symbol] ₁ and a slot representing matrix [symbol] ₊₂ based on the slot-specific matrix E^{S}, the intent label-specific matrix V^{I} and the slot label-specific matrices V^{S,k}; generating final intent outputs based on the multiple intent representing matrix [symbol] ₁ and the intent label-specific matrix V^{I}; generating final slot output based on the slot representing matrix [symbol] ₊₂ and the slot-specific matrix E^{S}; adjusting the SLU system based on an objective loss [symbol] .

### FIELD OF THE INVENTION

This disclosure relates generally to the field of automated spoken language understanding (SLU) and, more specifically, to systems and methods for Intent Detection and Slot Filling in SLU system based on a Joint Model for Multiple Intent Detection and Slot Filling with Intent-Slot Co-Attention.

### BACKGROUND OF THE INVENTION

Spoken language understanding (SLU) is a fundamental component in various applications, ranging from virtual assistants to chatbots and intelligent systems. In general, SLU systems process language expressed by human speech into a semantic representation understandable by the machines. SLU involves two tasks: intent detection to classify the intent of user utterances, and slot filling to extract useful semantic concepts. The intent detection task can be considered as a semantic utterance classification problem, while the slot filling task can be considered as a sequence labeling problem of contiguous words. Previous approaches to solving these two related tasks were typically proposed as two separated systems such as Support Vector Machines (SVMs) for intent determination and Conditional Random Fields (CRFs) for slot filling. However, in real-world scenarios, users may often express utterances with multiple intents, as illustrated in FIG. 1. This poses a challenge for single-intent systems, potentially resulting in poor performance.

The research study of detecting multiple intents and filling slots is becoming more popular because of its relevance to complicated real world situations. Recent advanced approaches, which are joint models based on graphs, might still face two potential issues: (i) the uncertainty introduced by constructing graphs based on preliminary intents and slots, which may transfer intent-slot correlation information to incorrect label node destinations, and (ii) direct incorporation of multiple intent labels for each token with reference to token-level intent voting might potentially lead to incorrect slot predictions, thereby hurting the overall performance. Consequently, improvements to methods and systems that enhance the performance of spoken language understanding systems would be required.

### SUMMARY OF THE INVENTION

To address these two issues, this invention discloses a jointly trained model for multi-intent detection and slot filling in consideration of correlations between intents and slot labels with an intent-slot co-attention mechanism. The joint model introduces an intent-slot co-attention mechanism and an underlying layer of label attention mechanism. These mechanisms enable the joint model to effectively capture correlations between intents and slot labels, eliminating the need for graph construction. The method also facilitates the transfer of correlation information in both directions: from intents to slots and from slots to intents, through multiple levels of label-specific representations, without relying on token-level intent information. By enabling seamless intent-to-slot and slot-to-intent information transfer, our co-attention mechanism facilitates the exchange of relevant information between intents and slots. This novel mechanism not only simplifies the model architecture, but also maintains the crucial interactions between intent and slot representations, thereby enhancing the overall performance.

A first aspect of the invention proposes a method for training of a spoken language understanding (SLU) system comprising: obtaining, by a task-shared encoder, an input utterance consisting of n word tokens w₁, w₂, . . . , wₙ; generating, by the task-shared encoder, a vector eᵢ to represent an i^{th} word token wᵢ based on the word tokens w₁, w₂, . . . , wₙ; generating, by an intent-specific encoder, intent-specific latent vectors

$${e}_{i}^{I}$$

for intent detection based on a sequence of vectors e_{1:n}, wherein the intent-specific latent vectors are concatenated to formulate an intent-specific matrix E^{I}; generating, by a slot-specific encoder, slot-specific latent vectors

$${e}_{i}^{S}$$

for slot filling based on the sequence of vectors e_{1:n}, wherein the slot-specific latent vectors are concatenated to formulate a slot-specific matrix E^{S}; generating, by a slot-specific encoder, an intent label-specific matrix V^{I} based on the intent-specific matrix E^{I}; generating, by the label attention component, slot label-specific matrices V^{S,k} based on the slot-specific matrix E^{S}, in which k∈{1, 2, . . . , [symbol] } and [symbol] is the number of hierarchy levels of slot labels; generating, by an intent-slot co-attention component, a multiple intent representing matrix [symbol] ₁ based on the slot-specific matrix E^{S}, the intent label-specific matrix V^{I} and the slot label-specific matrices V^{S,k}; generating, by the intent-slot co-attention component, a slot representing matrix [symbol] ₊₂ based on the slot-specific matrix E^{S}, the intent label-specific matrix V^{I} and the slot label-specific matrices V^{S,k}; generating, by a multiple intent decoder, final intent outputs based on the multiple intent representing matrix [symbol] ₁ and the intent label-specific matrix V^{I}; generating, by a slot decoder, final slot output based on the slot representing matrix [symbol] ₊₂ and the slot-specific matrix E^{S}; computing, by the multiple intent decoder, an intent detection loss [symbol] _{ID}; computing, by the slot decoder, a slot filling loss [symbol] _{SF}; and adjusting the SLU system based on an objective loss [symbol] , wherein the objective loss [symbol] is a weighted sum of the intent detection loss [symbol] _{ID} and the slot filling loss [symbol] _{SF}.

According to an embodiment of the first aspect, the method further comprises: receiving, by an audio input device, the input utterance; and generating, by an output device, an output utterance based on the input utterance.

According to an embodiment of the first aspect, the generating the vector eᵢ to represent the i^{th} word token wᵢ comprises concatenating a contextual word embedding

$${e}_{i}^{{BiLSTM}_{word}} ,$$

a self-attention embedding

$${e}_{i}^{SA}$$

and a character-level word embedding

$${e}_{{w}_{i}}^{{BiLSTM}_{char .}} ,$$

which is according to the following formula:

$${e}_{i} = {e}_{i}^{BiLSTMword} ⊕ {e}_{i}^{SA} ⊕ {e}_{{w}_{i}}^{BiLSTMchar .} \qquad ( 1 )$$

wherein:
the contextual word embedding

$${e}_{i}^{{BiLSTM}_{word}}$$

is an embedding of the token word wᵢ, derived by applying a single bidirectional BiLSTM layer to real valued embedding representations e_{w}_{₁}, e_{w}_{₂}, . . . , e_{w}_{ₙ};
the self-attention embedding

$${e}_{i}^{SA}$$

is an embedding of word wᵢ, derived by applying a single self-attention layer to the real valued embedding representations e_{w}_{₁}, e_{w}_{₂}, . . . , e_{w}_{ₙ}; and
the character-level word embedding

$${e}_{{w}_{i}}^{BiLSTMchar .}$$

is a character-level word embedding, derived by applying another single BILSTM (BiLSTM_{char.}) to the real valued embedding representations of characters in each word token wᵢ.

According to an embodiment of the first aspect, the generating, by the label attention component, the intent label-specific matrix V^{I} based on the intent-specific matrix E^{I}, comprises:
computing an intent label-specific attention weight matrix A^{I} based on a following formula:

$${A}^{I} = soft max ( {B}^{I} \times tanh ( {D}^{I} \times {E}^{I} ) )$$

wherein the softmax is performed at a row level to make sure that a summation of weights in each row is equal to 1, and B^{I}∈ [symbol] ^{|L}^{^{I}}^{|×d}^{ₐ}, D^{I}∈ [symbol] ^{d}^{ₐ}^{×d}^{ₑ}; and
generating the intent label-specific matrix V^{I} based on the intent-specific matrix E^{I} and the intent label-specific attention weight matrix A^{I}.

According to an embodiment of the first aspect, the generating, by the label attention component, the slot label-specific matrices V^{S,k} based on the slot-specific matrix E^{S}, comprises:
computing a slot label-specific attention weight matrix A^{S,k} based on a following formula:

$${A}^{S , k} = soft max ( {B}^{S , k} \times tanh ( {D}^{S , k} \times {E}^{S} ) )$$

wherein the softmax is performed at a row level to make sure that a summation of weights in each row is equal to 1, and B^{S,k}∈ [symbol] ^{|L}^{^{S,k}}^{|×d}^{ₐ}, D^{S,k}∈ [symbol] ^{d}^{ₐ}^{×d}^{ₑ}, in which L^{I} and L^{S,k} are the intent label set and the set of slot label types at the kth hierarchy level, respectively; and
generating the slot label-specific matrices V^{S,k} based on the slot-specific matrix E^{S} and the slot label-specific attention weight matrix A^{S,k}.

According to an embodiment of the first aspect, the method further comprises: updating the slot label-specific matrix V^{S,k} with a more coarse-grained label information from a (k−1)^{th} hierarchy level.

According to an embodiment of the first aspect, the generating, by the intent-slot co-attention component, the multiple intent representing matrix [symbol] ₁ based on the slot-specific matrix E^{S}, the intent label-specific matrix V^{I} and the slot label-specific matrices V^{S,k} comprises: generating a soft slot label matrix S based on the slot-specific matrix E^{S}; projecting each matrix Qₜ of the soft slot label matrix S, the intent label-specific matrix V^{I} and the slot label-specific matrices V^{S,k} into two spaces to obtain projected matrices [symbol] ₜ and \vec{Q}ₜ; computing a bilinear attention between a previous matrix Qₜ₋₁ and a current matrix Qₜ to measure a correlation Cₜ between their corresponding label types; generating the multiple intent representing matrix [symbol] ₁ based on the projected matrices [symbol] ₜ and \vec{Q}ₜ and the correlation Cₜ.

According to an embodiment of the first aspect, the generating, by the intent-slot co-attention component, the slot representing matrix [symbol] ₊₂ based on the slot-specific matrix E^{S}, the intent label-specific matrix V^{I} and the slot label-specific matrices V^{S,k}, comprises: generating the soft slot label matrix S based on the slot-specific matrix E^{S}; projecting each matrix Qₜ of the soft slot label matrix S, the intent label-specific matrix V^{I} and the slot label-specific matrices V^{S,k} into two spaces to obtain the projected matrices [symbol] ₜ and \vec{Q}ₜ; computing a bilinear attention between a previous matrix Qₜ₋₁ and a current matrix Qₜ to measure a correlation Cₜ between their corresponding label types; generating the slot representing matrix [symbol] ₊₂ based on the projected matrices [symbol] ₜ and \vec{Q}ₜ and the correlation Cₜ.

According to an embodiment of the first aspect, the generating, by the multiple intent decoder, the final intent outputs based on the multiple intent representing matrix [symbol] ₁ and the intent label-specific matrix V^{I} comprises: concatenating the multiple intent representing matrix [symbol] ₁ and the intent label-specific matrix V^{I} to create a final intent label-specific matrix H^{I}; computing a probability

$${p}_{j}^{I}$$

of a j^{th} intent label based on a j^{th} column vector of the final intent label-specific matrix H^{I} by using a corresponding weight vector and a sigmoid function; predicting a number of intents [symbol] ^{INP} based on the input utterance; and selecting intent labels with the top highest probabilities

$${p}_{j}^{I}$$

based on the number of intents [symbol] ^{INP} as the final intent outputs.

According to an embodiment of the first aspect, the generating, by the slot decoder, the final slot output based on the slot representing matrix [symbol] ₊₂ and the slot-specific matrix E^{S} comprises: concatenating the slot representing matrix [symbol] ₊₂ and the slot-specific matrix E^{S} to create a final slot filling-specific matrix H^{S}; project each column vector

$${v}_{i}^{S}$$

of the final slot filling-specific matrix H^{S} to obtain a projected column vector

$${h}_{i}^{S} ;$$

and feeding the projected column vectors

$${h}_{i}^{S}$$

into a linear-chain CRF predictor for slot label prediction to obtain the final slot output.

A second aspect of the invention proposes a spoken language understanding (SLU) system comprising a task-shared encoder, an intent-specific encoder, a slot-specific encoder, a label attention component, an intent-slot co-attention component, a multiple intent decoder and a slot decoder, wherein each of the components is configured to perform operations comprising: obtaining, by the task-shared encoder, an input utterance consisting of n word tokens w₁, w₂, . . . , wₙ; generating, by the task-shared encoder, a vector eᵢ to represent an i^{th} word token wᵢ based on the word tokens w₁, w₂, . . . , wₙ; generating, by the intent-specific encoder, intent-specific latent vectors

$${e}_{i}^{I}$$

for intent sequence of vectors e_{1:n}, wherein the intent-specific latent vectors are concatenated to formulate an intent-specific matrix E^{I}; generating, by the slot-specific encoder, slot-specific latent vectors

$${e}_{i}^{S}$$

for slot filling based on the sequence of vectors e_{1:n}, wherein the slot-specific latent vectors are concatenated to formulate a slot-specific matrix E^{S}; generating, by the label attention component, an intent label-specific matrix V^{I} based on the intent-specific matrix E^{I}; generating, by the label attention component, slot label-specific matrices V^{S,k} based on the slot-specific matrix E^{S}, in which k∈{1, 2, . . . , [symbol] } and [symbol] is the number of hierarchy levels of slot labels; generating, by the intent-slot co-attention component, a multiple intent representing matrix [symbol] ₁ based on the slot-specific matrix E^{S}, the intent label-specific matrix V^{I} and the slot label-specific matrices V^{S,k}; generating, by the intent-slot co-attention component, a slot representing matrix [symbol] ₊₂ based on the slot-specific matrix E^{S}, the intent label-specific matrix V^{I} and the slot label-specific matrices V^{S,k}; generating, by the multiple intent decoder, final intent outputs based on the multiple intent representing matrix [symbol] ₁ and the intent label-specific matrix V^{I}; generating, by the slot decoder, final slot output based on the slot representing matrix [symbol] ₊₂ and the slot-specific matrix E^{S}; computing, by the multiple intent decoder, an intent detection loss [symbol] _{ID}; computing, by the slot decoder, a slot filling loss [symbol] _{SF}; and adjusting the SLU system based on an objective loss [symbol] , wherein the objective loss ζ is a weighted sum of the intent detection loss [symbol] _{ID} and the slot filling loss [symbol] _{SF}.

According to an embodiment of the second aspect, the instructions further cause the system to perform the operations of: receiving, by an audio input device, the input utterance; and generating, by an output device, an output utterance based on the input utterance.

According to an embodiment of the second aspect, the generating the vector eᵢ to represent the i^{th} word token wᵢ comprises concatenating a contextual word embedding

$${e}_{i}^{B i L S T {M}_{w o r d}} ,$$

a self-attention embedding

$${e}_{i}^{S A}$$

and a character-level word embedding

$${e}_{{w}_{i}}^{B i L S T {M}_{c har .}} ,$$

which is according to the following formula:

$${e}_{i} = {e}_{i}^{BiLSTMword} ⊕ {e}_{i}^{SA} ⊕ {e}_{{w}_{i}}^{BiLSTMchar .} ;$$

wherein:
the contextual word embedding

$${e}_{i}^{B i L S T {M}_{w o r d}}$$

is an embedding of the token word wᵢ, derived by applying a single bidirectional BILSTM layer to real valued embedding representations e_{w}_{₁}, e_{w}_{₂}, . . . , e_{w}_{ₙ};
the self-attention embedding

$${e}_{i}^{S A}$$

is an embedding or word wᵢ, derived by applying a single self-attention layer to the real valued embedding representations e_{w}_{₁}, e_{w}_{₂}, . . . , e_{w}_{ₙ}; and
the character-level word embedding

$${e}_{{w}_{i}}^{B i L S T M c har .}$$

is a character-level word embedding, derived by applying another single BILSTM (BiLSTM_{char.}) to the real valued embedding representations of characters in each word token wᵢ.

According to an embodiment of the second aspect, the generating, by the label attention component, the intent label-specific matrix V^{I} based on the intent-specific matrix E^{I}, comprises:
computing an intent label-specific attention weight matrix A^{I} based on a following formula:

$${A}^{I} = s o ftm ax ( {B}^{I} \times tanh ( {D}^{I} \times {E}^{I} ) )$$

wherein the softmax is performed at a row level to make sure that a summation of weights in each row is equal to 1, and B^{I}∈ [symbol] ^{|L}^{^{I}}^{|×d}^{ₐ}, D^{I}∈ [symbol] ^{d}^{ₐ}^{×d}^{ₑ}; and
generating the intent label-specific matrix V^{I} based on the intent-specific matrix E^{I} and the intent label-specific attention weight matrix A^{I}.

According to an embodiment of the second aspect, the generating, by the label attention component, the slot label-specific matrices V^{S,k} based on the slot-specific matrix E^{S}, comprises:
computing a slot label-specific attention weight matrix A^{S,k} based on a following formula:

$${A}^{S , k} = s o ftm ax ( {B}^{S , k} \times tanh ( {D}^{S , k} \times {E}^{S} ) )$$

wherein the softmax is performed at a row level to make sure that a summation of weights in each row is equal to 1, and B^{S,k}∈ [symbol] ^{|L}^{^{S,k}}^{|×d}^{ₐ}, D^{S,k}∈ [symbol] ^{d}^{ₐ}^{×d}^{ₑ}, in which L^{I} and L^{S,k} are the intent label set and the set of slot label types at the k^{th} hierarchy level, respectively; and
generating the slot label-specific matrices V^{S,k} based on the slot-specific matrix E^{S} and the slot label-specific attention weight matrix A^{S,k}.

According to an embodiment of the second aspect, the instructions further cause the system to perform the operations of: updating the slot label-specific matrix V^{S,k} with a more coarse-grained label information from a (k−1)^{th} hierarchy level.

According to an embodiment of the second aspect, the generating, by the intent-slot co-attention component, the multiple intent representing matrix [symbol] ₁ based on the slot-specific matrix E^{S}, the intent label-specific matrix V^{I} and the slot label-specific matrices V^{S,k} comprises: generating a soft slot label matrix S based on the slot-specific matrix E^{S}; projecting each matrix Qₜ of the soft slot label matrix S, the intent label-specific matrix V^{I} and the slot label-specific matrices V^{S,k} into two spaces to obtain projected matrices [symbol] ₜ and \vec{Q}ₜ; computing a bilinear attention between a previous matrix Qₜ₋₁ and a current matrix Qₜ to measure a correlation Cₜ between their corresponding label types; generating the multiple intent representing matrix [symbol] ₁ based on the projected matrices [symbol] ₜ and \vec{Q}ₜ and the correlation Cₜ.

According to an embodiment of the second aspect, the generating, by the intent-slot co-attention component, the slot representing matrix [symbol] ₊₂ based on the slot-specific matrix E^{S}, the intent label-specific matrix V^{I} and the slot label-specific matrices V^{S,k}, comprises: generating the soft slot label matrix S based on the slot-specific matrix E^{S}; projecting each matrix Qₜ of the soft slot label matrix S, the intent label-specific matrix V^{I} and the slot label-specific matrices V^{S,k} into two spaces to obtain the projected matrices [symbol] ₜ and \vec{Q}ₜ; computing a bilinear attention between a previous matrix Qₜ₋₁ and a current matrix Qₜ to measure a correlation Cₜ between their corresponding label types; generating the slot representing matrix [symbol] ₊₂ based on the projected matrices [symbol] ₜ and \vec{Q}ₜ and the correlation Cₜ.

According to an embodiment of the second aspect, the generating, by the multiple intent decoder, the final intent outputs based on the multiple intent representing matrix [symbol] ₁ and the intent label-specific matrix V^{I} comprises: concatenating the multiple intent representing matrix [symbol] ₁ and the intent label-specific matrix V^{I} to create a final intent label-specific matrix H^{I}; computing a probability

$${p}_{j}^{I}$$

of a j^{th} intent label based on a j^{th} column vector of the final intent label-specific matrix H^{I} by using a corresponding weight vector and a sigmoid function; predicting a number of intents [symbol] ^{INP} based on the input utterance; and selecting intent labels with the top highest probabilities

$${p}_{j}^{I}$$

based on the number of intents [symbol] ^{INP} as the final intent outputs.

According to an embodiment of the second aspect, the generating, by the slot decoder, the final slot output based on the slot representing matrix [symbol] ₊₂ and the slot-specific matrix E^{S} comprises: concatenating the slot representing matrix [symbol] ₊₂ and the slot-specific matrix E^{S} to create a final slot filling-specific matrix H^{S}; project each column vector

$${ν}_{i}^{S}$$

of the final slot filling-specific matrix H^{S} to obtain a projected column vector

$${h}_{i}^{S} ;$$

and feeding the projected column vectors

$${h}_{i}^{S}$$

into a linear-chain CRF predictor for slot label prediction to obtain the final slot output.

A third aspect of the invention proposes a spoken language understanding (SLU) system comprising: one or more processors; and a computer-readable medium having instructions stored there on, which, when executed by the one or more processors, cause the system to perform operations comprising: obtaining an input utterance consisting of n word tokens w₁, w₂, . . . , wₙ; generating a vector eᵢ to represent an i^{th} word token wᵢ based on the word tokens w₁, w₂, . . . , wₙ; generating intent-specific latent vectors

$${e}_{i}^{I}$$

for intent detection based on a sequence of vectors e_{1:n}, wherein the intent-specific latent vectors are concatenated to formulate an intent-specific matrix E^{I}; generating slot-specific latent vectors

$${e}_{i}^{s}$$

for slot filling based on the sequence of vectors e_{1:n}, wherein the slot-specific latent vectors are concatenated to formulate a slot-specific matrix E^{S}; generating an intent label-specific matrix V^{I} based on the intent-specific matrix E^{I}; generating slot label-specific matrices V^{S,k} based on the slot-specific matrix E^{S}, in which k∈{1, 2, . . . , [symbol] } and [symbol] is the number of hierarchy levels of slot labels; generating a multiple intent representing matrix [symbol] ₁ based on the slot-specific matrix E^{S}, the intent label-specific matrix V^{I} and the slot label-specific matrices V^{S,k}; generating a slot representing matrix [symbol] ₊₂ based on the slot-specific matrix E^{S}, the intent label-specific matrix V^{I} and the slot label-specific matrices V^{S,k}; generating final intent outputs based on the multiple intent representing matrix [symbol] ₁ and the intent label-specific matrix V^{I}; generating a final slot output based on the slot representing matrix [symbol] ₊₂ and the slot-specific matrix E^{S}; computing an intent detection loss [symbol] _{ID}; computing a slot filling loss [symbol] _{SF}; and adjusting the SLU system based on an objective loss [symbol] wherein the objective loss [symbol] is a weighted sum of the intent detection loss [symbol] _{ID} and the slot filling loss [symbol] _{SF}.

According to an embodiment of the third aspect, the instructions further cause the system to perform the operations of: receiving, by an audio input device, the input utterance; and generating, by an output device, an output utterance based on the input utterance.

According to an embodiment of the third aspect, the generating the vector eᵢ to represent the i^{th} word token wᵢ comprises concatenating a contextual word embedding

$${e}_{i}^{{BiLSTM}_{word}} ,$$

a self-attention embedding

$${e}_{i}^{SA}$$

and a character-level word embedding

$${e}_{{w}_{i}}^{{BiLSTM}_{char .}} ,$$

which is according to a following formula:

$${e}_{i} = {e}_{i}^{BiLSTMword} ⊕ {e}_{i}^{S A} ⊕ {e}_{{w}_{i}}^{B i L S T M c har .} ;$$

wherein:
the contextual word embedding

$${e}_{i}^{{BiLSTM}_{word}}$$

is an embedding of the token word wᵢ, derived by applying a single bidirectional BILSTM layer to real valued embedding representations e_{w}_{₁}, e_{w}_{₂}, . . . , e_{w}_{ₙ};
the self-attention embedding

$${e}_{i}^{SA}$$

is an embedding of word wᵢ, derived by applying a single self-attention layer to the real valued embedding representations e_{w}_{₁}, e_{w}_{₂}, . . . , e_{w}_{ₙ}; and
the character-level word embedding

$${e}_{{w}_{i}}^{{BiLSTM}_{char .}}$$

is a character-level word embedding, derived by applying another single BILSTM (BiLSTM_{char.}) to the real valued embedding representations of characters in each word token wᵢ.

According to an embodiment of the third aspect, the generating the intent label-specific matrix V^{I} based on the intent-specific matrix E^{I}, comprises:
computing an intent label-specific attention weight matrix A^{I} based on a following formula:

$${A}^{I} = softmax ( {B}^{I} \times tanh ( {D}^{I} \times {E}^{I} ) )$$

wherein the softmax is performed at a row level to make sure that a summation of weights in each row is equal to 1, and B^{I}∈ [symbol] ^{|L}^{^{I}}^{|×d}^{ₐ}, D^{I}∈ [symbol] ^{d}^{ₐ}^{×d}^{ₑ}; and
generating the intent label-specific matrix V^{I} based on the intent-specific matrix E^{I} and the intent label-specific attention weight matrix A^{I}.

According to an embodiment of the third aspect, the generating the slot label-specific matrices V^{S,k} based on the slot-specific matrix E^{S}, comprises:
computing a slot label-specific attention weight matrix A^{S,k} based on a following formula:

$${A}^{S , k} = softmax ( {B}^{S , k} \times tanh ( {D}^{S , k} \times {E}^{S} ) )$$

wherein the softmax is performed at a row level to make sure that a summation of weights in each row is equal to 1, and B^{S,k}∈ [symbol] ^{|L}^{^{S,k}}^{|×d}^{ₐ}, D^{S,k}∈ [symbol] ^{d}^{ₐ}^{×d}^{ₑ}, in which L^{I} and L^{S,k} are the intent label set and the set of slot label types at the k^{th} hierarchy level, respectively; and
generating the slot label-specific matrices V^{S,k} based on the slot-specific matrix E^{S} and the slot label-specific attention weight matrix A^{S,k}.

According to an embodiment of the third aspect, the instructions further cause the system to perform the operations of: updating the slot label-specific matrix V^{S,k} with a more coarse-grained label information from a (k−1)^{th} hierarchy level.

According to an embodiment of the third aspect, the generating the multiple intent representing matrix [symbol] ₁ based on the slot-specific matrix E^{S}, the intent label-specific matrix V^{I} and the slot label-specific matrices V^{S,k} comprises: generating a soft slot label matrix S based on the slot-specific matrix E^{S}; projecting each matrix Qₜ of the soft slot label matrix S, the intent label-specific matrix V^{I} and the slot label-specific matrices V^{S,k} into two spaces to obtain projected matrices [symbol] ₜ and \vec{Q}ₜ; computing a bilinear attention between a previous matrix Qₜ₋₁ and a current matrix Qₜ to measure a correlation Cₜ between their corresponding label types; generating the multiple intent representing matrix [symbol] ₁ based on the projected matrices [symbol] ₜ and \vec{Q}ₜ and the correlation Cₜ.

According to an embodiment of the third aspect, the generating the slot representing matrix [symbol] ₊₂ based on the slot-specific matrix E^{S}, the intent label-specific matrix V^{I} and the slot label-specific matrices V^{S,k}, comprises: generating the soft slot label matrix S based on the slot-specific matrix E^{S}; projecting each matrix Qₜ of the soft slot label matrix S, the intent label-specific matrix V^{I} and the slot label-specific matrices V^{S,k} into two spaces to obtain the projected matrices [symbol] ₜ and \vec{Q}ₜ; computing a bilinear attention between a previous matrix Qₜ₋₁ and a current matrix Qₜ to measure a correlation Cₜ between their corresponding label types; generating the slot representing matrix [symbol] ₊₂ based on the projected matrices [symbol] ₜ and \vec{Q}ₜ and the correlation Cₜ.

According to an embodiment of the third aspect, the generating the final intent outputs based on the multiple intent representing matrix [symbol] ₁ and the intent label-specific matrix V^{I} comprises: concatenating the multiple intent representing matrix [symbol] ₁ and the intent label-specific matrix V^{I} to create a final intent label-specific matrix H^{I}; computing a probability

$${p}_{j}^{I}$$

of a j^{th} intent label based on a j^{th} column vector of the final intent label-specific matrix H^{I} by using a corresponding weight vector and a sigmoid function; predicting a number of intents [symbol] ^{INP} based on the input utterance; and selecting intent labels with the top highest probabilities

$${p}_{j}^{I}$$

based on the number of intents [symbol] ^{INP} as the final intent outputs.

According to an embodiment of the third aspect, the generating the final slot output based on the slot representing matrix [symbol] ₊₂ and the slot-specific matrix E^{S} comprises: concatenating the slot representing matrix [symbol] ₊₂ and the slot-specific matrix E^{S} to create a final slot filling-specific matrix H^{S}; project each column vector

$${v}_{i}^{S}$$

of the final slot filling-specific matrix H^{S} to obtain a projected column vector

$${h}_{i}^{S} ;$$

and feeding the projected column vectors

$${h}_{i}^{S}$$

into a linear-chain CRF predictor for slot label prediction to obtain the final slot output.

A fourth aspect of the invention proposes a computer-readable storage medium comprising instructions that, when executed by at least one processor of a machine, cause the machine to perform the method of the first aspect.

A fifth aspect of the invention proposes a non-transitory computer-readable storage medium comprising instructions that, when executed by at least one processor of a machine, cause the machine to perform the method of the first aspect.

### BRIEF DESCRIPTION OF DRAWINGS

FIG. 1 is an example of utterance with multiple intents and slots.

FIG. 2A is a schematic diagram of one embodiment of an automatic Spoken Language Understanding (SLU) system.

FIG. 2B is a schematic diagram of another embodiment of an automatic Spoken Language Understanding (SLU) system.

FIG. 3 is an illustration of the architecture of the SLU system.

FIG. 4 is a block diagram of a process for automated intent detection and generating of machine-readable dialogue phrases via a slot filling process based on the architecture of the joint model.

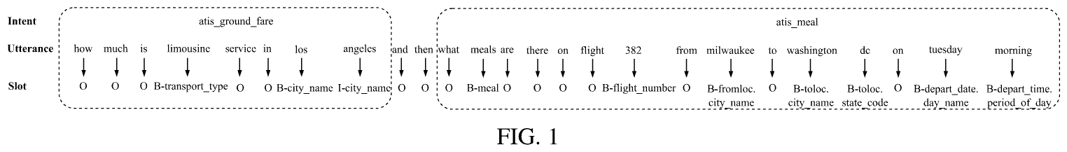

### DETAILED DESCRIPTION OF THE INVENTION

For the purposes of promoting an understanding of the principles of the embodiments disclosed herein, reference will now be made to the drawings and description in the following written specification. These references are not intended to limit the scope of the subject matter. The present disclosure also includes any alterations and modifications to the illustrated embodiments, and includes further applications of the principles of the disclosed embodiments as would normally occur to one skilled in the art to which this disclosure pertains.

As used herein, the term “intent” refer to a numeric identifier that associates a plurality of words in an input utterance received from a user with a machine-readable dialog phrase stored in memory. The dialogue phrase encodes information about the task that the user wants to perform based on information in the original input from the user.

As used herein, the term “slot” refers to a field in a machine-readable dialog phrase that maps a single word or a small number of words in the input text to variables that are understandable in the automatic spoken language understanding dialog framework. As described above, the machine-readable dialog phrase corresponds to a task that is performed by the SLU system, which identifies the task by detecting the intent of the input. Each slot represents a variable input field for a given task.

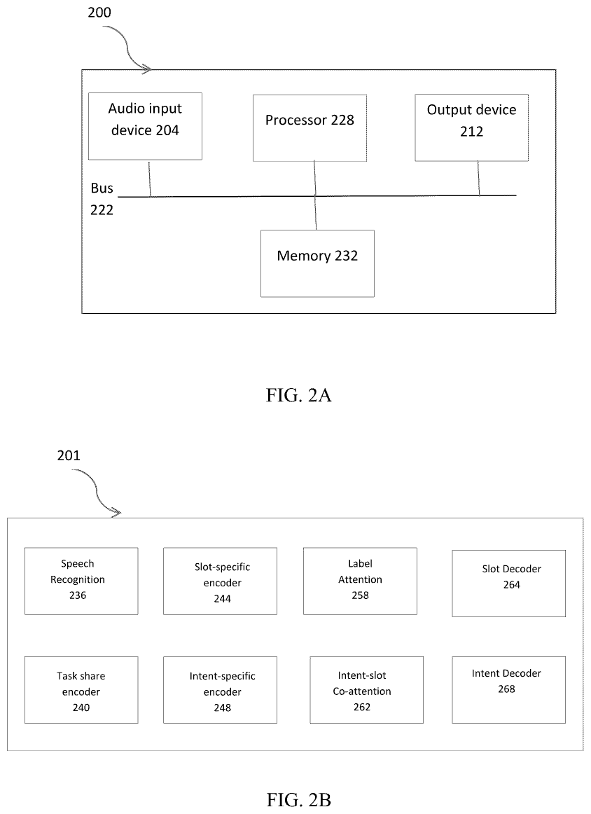

FIG. 2A depicts a Spoken Language Understanding (SLU) system 200, the system 200 performing operations of mapping words in an input phrase received from a human user to a dialogue phrase having a structure with slots filled by selected words provided in the input. The system 200 includes an audio input device 204, an output device 212, a processor 228, and a memory 232, a bus 222. The audio input device 204, the output device 212, the processor 228, and the memory 232 may communicate with each other via the bus 222.

In the system 200, the audio input device 204 is, for example, a microphone or a series of microphones that receive spoken input from a human user.

In system 200, output device 212 is an audio output device or a visual display device that produces output, for example, in a dialog system. The output is based at least in part on information provided to the system 200 from a user via the audio input device 204. As described in more detail below, the system 200 receives speech or text input from a user, encodes the input, and generates or decodes both an intent label and slots that include words extracted from the input text. The system 200 processes the structured dialogue phrase with specific terms that are understandable in the spoken language understanding framework to generate an output response based on input from the user. Output device 212 provides an output to the user based on input from the user that mimics the dialog response desired by the user, but system 200 generates the dialog response in an automated manner.

In the system 200, the processor 228 is a digital logic device that includes, for example, one or more of the following: a microprocessor Central Processing Unit (CPU), a microcontroller, a Digital Signal Processor (DSP), a Field Programmable Gate Array (FPGA), a Graphics Processing Unit (GPU), an Application Specific Integrated Circuit (ASIC), or any other suitable digital logic device that performs the functions and acts of system 200 described herein. In some embodiments, the processor 228 includes acceleration hardware that implements the operations of the RNN encoder and decoder described herein in an efficient manner, although other processing hardware, including a CPU and GPU, may also implement the RNN encoder and decoder. The processor 228 is operatively connected to the audio input device 204, the output device 212, and the memory 232.

In the system 200, the memory 232 includes: one or more volatile memory devices, such as Random Access Memory (RAM), and one or more nonvolatile memory devices, such as magnetic or solid state disks. The memory 232 stores programming instructions that the processor 228 executes to carry out the functions and acts described herein.

FIG. 2B depicts a Spoken Language Understanding (SLU) system 201. The system 201 comprises a speech recognizer 236, a RNN task-shared encoder 240, a RNN slot specific encoder 244, a RNN intent specific encoder 248, a Label attention component 258, the Intent-Slot Co-attention component 262, the RNN slot decoder 264, the intent decoder 268.

In the memory 232, the speech recognizer 236 is a prior art Automatic Speech Recognition (ASR) system that includes, for example, software and models that convert electrical signals received by the system 201 into sequences of machine-readable representations of spoken words.

The task-share encoder 236, slot-specific encoder 244, intent-specific encoder 248 are Bidirectional Long Short-Term Memory (BiLSTM) based encoders.

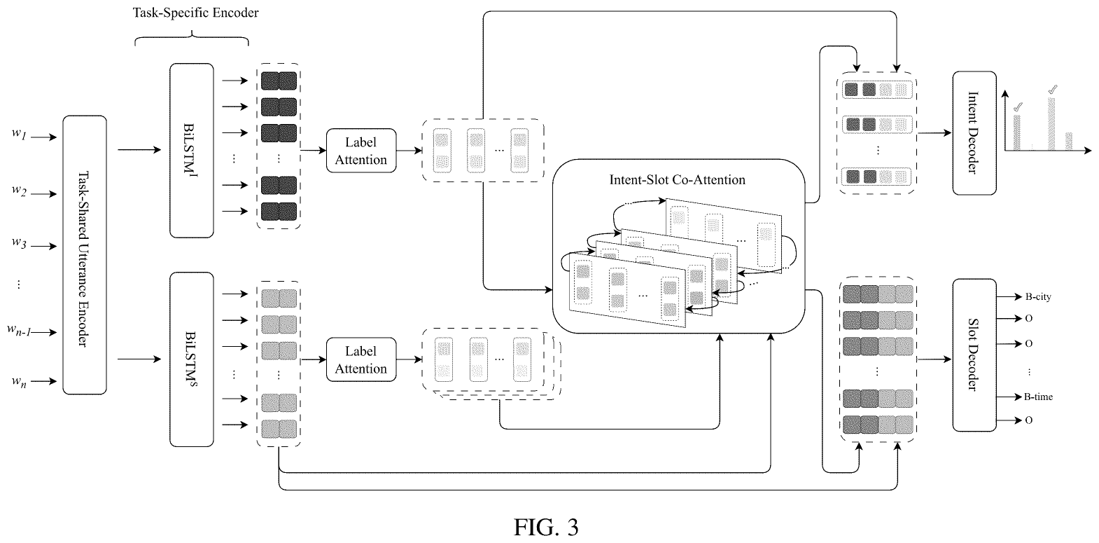

FIG. 3 illustrates the architecture of the joint model for Multiple Intent Detection and Slot Filling with Intent-Slot Co-Attention used in system 201.

Given an input utterance consisting of n word tokens w₁, w₂, . . . , wₙ, the multiple intent detection task is a multi-label classification problem that predicts multiple intents of the input utterance. Meanwhile, the slot filling task can be viewed as a sequence labeling problem that predicts a slot label for each token of the input utterance.

The joint model consists of four main components: (i) task-shared and task-specific utterance encoders, (ii) label attention, (iii) intent-slot co-attention, and (iv) intent and slot decoders. The encoders component aims to generate intent-aware and slot-aware task-specific feature vectors for intent detection and slot filling, respectively. The label attention component takes these task-specific vectors as input and outputs intent and slot label-specific matrices. The intent-slot co-attention component utilizes the label-specific vectors and the slot-aware task-specific vectors to simultaneously learn correlations between intent detection and slot filling through multiple intermediate layers. The output vectors generated by this co-attention component are used to construct input vectors for the intent and slot decoders which predict multiple intents and slot labels, respectively.

The task-shared encoder creates a vector eᵢ to represent the i^{th} word token wᵢ by concatenating contextual word embeddings

$${e}_{i}^{{BiLSTM}_{word}} and {e}_{i}^{SA} ,$$

and character-level word embedding

$${e}_{{w}_{i}}^{{BiLSTM}_{char .}} :$$

$${e}_{i} = {e}_{i}^{BiLSTMword} ⊕ {e}_{i}^{SA} ⊕ {e}_{{w}_{i}}^{BiLSTMchar .} \qquad ( 1 )$$

Here, a sequence e_{w}_{₁}_{:w}_{ₙ} of real-valued word embeddings e_{w}_{₁}, e_{w}_{₂} . . . , e_{w}_{ₙ} are fed into a single bidirectional LSTM (BILSTM_{word}) layer and a single self-attention layer to produce the contextual feature vectors

$${e}_{i}^{{BiLSTM}_{word}} and {e}_{i}^{SA} ,$$

respectively. In addition, the character-level word embedding

$${e}_{{w}_{i}}^{BiLSTMchar .}$$

is derived by applying another single BiLSTM (BiLSTM_{char.}) to the sequence of real-valued embedding representations of characters in each word wᵢ.

The task-specific encoders pass the sequence of vectors e_{1:n} as input to two different single BILSTM layers to produce task-specific latent vectors

$${e}_{i}^{I} = {BiLSTM}^{I} ( {e}_{1 : n} , i ) and {e}_{i}^{S} = {BiLSTM}^{S} ( {e}_{1 : n} , i ) ∈ {ℝ}^{{d}_{e}}$$

for intent detection and slot filling, respectively. These task-specific vectors are concatenated to formulate task-specific matrices E^{I} and E^{S} as follows:

$${E}^{I} = [ {e}_{1}^{I} , {e}_{2}^{I} , … {e}_{n}^{I} ] ∈ {ℝ}^{{d}_{e} \times n} \qquad ( 2 )$$

$${E}^{S} = [ {e}_{1}^{S} , {e}_{2}^{S} , … {e}_{n}^{S} ] ∈ {ℝ}^{{d}_{e} \times n} . \qquad ( 3 )$$

The word tokens in the input utterance might make different contributions to each of the intent and slot labels. In label attention, intent and slot label-specific matrices are extracted based on the task-specific vectors representing intent and slot labels. Thus a hierarchical label attention mechanism is introduced, adapting the attention mechanism from “Thanh Vu, Dat Quoc Nguyen, and Anthony Nguyen. 2020. A Label Attention Model for ICD Coding from Clinical Text. In Proceedings of IJCAI-20, pages 3335-3341”, to take such slot label hierarchy information into extracting the label-specific vectors.

Formally, the label attention mechanism takes the task-specific matrix (here, E^{I} from Equation 2 and E^{S} from Equation 3) as input and computes a label-specific attention weight matrix (here, A^{I}∈ [symbol] ^{L}^{^{I}}^{|×n} and A^{S,k}∈ [symbol] ^{|L}^{^{S,k}}^{|×n} at the k^{th} hierarchy level of slot labels) as follows:

$${A}^{I} = softmax ( {B}^{I} \times tanh ( {D}^{I} \times {E}^{I} ) ) \qquad ( 4 )$$

$${A}^{S , k} = softmax ( {B}^{S , k} \times tanh ( {D}^{S , k} \times {E}^{S} ) ) \qquad ( 5 )$$

where softmax is performed at the row level to make sure that the summation of weights in each row is equal to 1; and B^{I}∈ [symbol] ^{|L}^{^{I}}^{|×d}^{ₐ}, D^{I}∈ [symbol] ^{d}^{ₐ}^{×d}^{ₑ}, B_{S,k}∈ [symbol] ^{|L}^{^{S,k}}^{|×d}^{ₐ}, and D^{S,k}∈ [symbol] ^{d}^{ₐ}^{×d}^{ₑ}, in which L^{I} and L^{S,k} are the intent label set and the set of slot label types at the k^{th} hierarchy level, respectively.

Here, k∈{1, 2, . . . , [symbol] } where [symbol] is the number of hierarchy levels of slot labels, and thus [symbol] is the set of “fine-grained” slot label types (i.e. all original slot labels in the training data).

After that, label-specific representation matrices V^{I} and V_{S,k} are computed by multiplying the task-specific matrices E^{I} and E^{S} with the attention weight matrices A^{I} and A^{S,k}, respectively, as:

$${V}^{I} = {E}^{I} \times {( {A}^{I} )}^{⊤} \qquad ( 6 )$$

$${V}^{S , k} = {E}^{S} \times {( {A}^{S , k} )}^{⊤} . \qquad ( 7 )$$

Here, the j^{th} columns

$${v}_{j}^{I} from {V}^{I} ∈ {ℝ}^{{d}_{e} \times \vert {L}^{I} \vert} and {v}_{j}^{S , k} from {V}^{S , k} ∈ {ℝ}^{{d}_{e} \times \vert {L}^{S , k} \vert}$$

are referred to as vector representations of the input utterance with reference to the j^{th} label in L^{I} and L^{S,k}, respectively.

To capture slot label hierarchy information, at k≥2, taking

$${v}_{j}^{S , k - 1} ,$$

we compute the probability

$${p}_{j}^{S , k - 1}$$

of the j^{th} slot label at the (k−1)^{th} hierarchy level given the utterance, using a corresponding weight vector

$${w}_{j}^{S , k - 1} ∈ {ℝ}^{{d}_{e}}$$

and the sigmoid function. We project the vector p^{S,k-1} of label probabilities

$${p}_{j}^{S , k - 1}$$

using a projection matrix Z^{S,k-1}∈ [symbol] ^{d}^{ₚ}^{×|l}^{^{S,k−1}}^{|}, and then concatenate the projected vector output with each slot label-specific vector of the k^{th} hierarchy level:

$${p}_{j}^{S , k - 1} = sigmoid ( {w}_{j}^{S , k - 1} \cdot {v}_{j}^{S , k - 1} ) \qquad ( 8 )$$

$${P}^{S , k - 1} = {[ {p}_{1}^{S , k - 1} , {p}_{2}^{S , k - 1} , … , {p}_{\vert {L}^{S , k - 1} \vert}^{S , k - 1} ]}^{⊤} \qquad ( 9 )$$

$${v}_{j}^{S , k - 1} ← {v}_{j}^{S , k} ⊕ {Z}^{S , k - 1} \times {p}^{S , k - 1} \qquad ( 10 )$$

$${V}^{S , k} = [ {v}_{1}^{S , k} , {v}_{2}^{S , k} , … , {v}_{\vert {L}^{S , k} \vert}^{S , k} ] \qquad ( 11 )$$

The slot label-specific matrix V^{S,k} at k≥2 is now updated with more “coarse-grained” label information from the (k−1)^{th} hierarchy level.

The intent-slot co-attention component utilizes the label-specific vectors and the slot-aware task-specific vectors to simultaneously learn correlations between intent detection and slot filling through multiple intermediate layers. The output vectors generated by this co-attention component are used to construct input vectors for the intent and slot decoders which predict multiple intents and slot labels, respectively.

The co-attention mechanism creates a matrix S∈ [symbol] ^{d}^{ₛ}^{×n} whose each column represents a “soft” slot label embedding for each input word token, based on its task-specific feature vector:

$$S = {W}^{S} softmax ( {U}^{S} {E}^{S} ) \qquad ( 12 )$$

where W^{S}∈ [symbol] ^{d}^{ₛ}^{×(2|} [symbol] ^{|+1)}, U^{S}∈ [symbol] ^{(2|} [symbol] ^{|+1)×d}^{ₑ} and 2| [symbol] |+1 is the number of BIO-based slot tag labels (including the “O” label) as we formulate the slot filling task as a BIO-based sequence labeling problem. Recall that [symbol] is the set of “fine-grained” slot label types without “B-” and “I-” prefixes, not including the “O” label. Here, softmax is performed at the column level.

The intent-slot co-attention mechanism takes a sequence of [symbol] +2 input feature matrices V^{I}, V^{S,1}, V^{S,2}, . . . , [symbol] , S (computed as in Equations 6, 7, 11, 12) to perform intent-slot co-attention.

For notation simplification, the input feature matrices of our mechanism are orderly referred to as Q₁, Q₂, . . . , [symbol] ₊₂, where Q₁=V^{I}, Q₂=V^{S,1}, . . . , [symbol] ₊₁= [symbol] and [symbol] ₊₂=S; and dₜ×mₜ is the size of the corresponding matrix Qₜ whose each column is referred to as a label-specific vector: d₁=dₑ, m₁=|L^{I}|; d₂=dₑ, m₂=|L^{S,1}|; d₃=dₑ+dₚ, m₃=|L^{S,2}|; . . . ; [symbol] ₊₁=dₑ+dₚ, [symbol] ₊₁=| [symbol] |; [symbol] ₊₂=dₛ, [symbol] ₊₂=n.

As each intermediate layer's matrix Qₜ has different interactions with the previous layer's matrix Qₜ₋₁ and the next layer's matrix Qₜ₊₁, Qₜ is projected into two vector spaces to ensure that all label-specific column vectors have the same dimension:

$${\vec{Q}}_{t} = {\vec{W}}_{t} {Q}_{t} ; {t}_{} = {t}_{} {Q}_{t} \qquad ( 13 )$$

Where \vec{W}ₜ and [symbol] ₜ∈ [symbol] ^{d×d}^{ₜ} are projection weight matrices; and thus \vec{Q}ₜ and [symbol] ₜ∈ [symbol] ^{d×m}^{ₜ}. A bilinear attention between two matrices Qₜ₋₁ and Qₜ is computed to measure the correlation between their corresponding label types:

$${C}_{t} = {Q}_{t - 1}^{⊤} {X}_{t} {Q}_{t} \qquad ( 14 )$$

where Xₜ∈ [symbol] ^{d}^{_{t−1}}^{×d}^{ₜ}, and thus Cₜ∈ [symbol] ^{m}^{_{t−1}}^{×m}^{ₜ}

The co-attention mechanism allows the intent-to-slot and slot-to-intent information transfer by computing attentive label-specific representation matrices as follows:

$${t}_{} = \{ \begin{matrix}tanh ( {t + 1}_{} {C}_{t + 1}^{⊤} + {t}_{} ) , & if t = ℓ + 1 \\ tanh ( {t - 1}_{} {C}_{t + 1}^{⊤} + {t}_{} ) , & otherwise\end{matrix} \qquad ( 15 )$$

$${\vec{H}}_{t} = \{ \begin{matrix}tanh ( {\vec{Q}}_{t - 1} {C}_{t} + {\vec{Q}}_{t} ) , & if t = 2 \\ tanh ( {\vec{H}}_{t - 1} {C}_{t} + {\vec{Q}}_{t} ) , & otherwise\end{matrix} \qquad ( 16 )$$

Wherein, [symbol] ₁∈ [symbol] ^{d×|L}^{^{I}}^{|} and [symbol] ₊₂∈ [symbol] ^{d×n} as computed following Equations 15 and 16 as the matrix outputs representing intents and slot mentions, respectively.

In Multiple intent decoder, the multiple intent detection task is formulated as a multi-label classification problem. We concatenate V^{I} (computed as in Equation 6) and [symbol] ₁ (computed following Equation 15) to create an intent label-specific matrix H^{I}∈ [symbol] ^{(d}^{ₑ}^{+d)×|L}^{^{I}}^{|} where its j^{th} column vector

$${v}_{j}^{I} ∈ {ℝ}^{{d}_{e} + d}$$

is referred to as the final vector representation of the input utterance with reference to the j^{th} intent label in L^{I}. Taking

$${v}_{j}^{I} ,$$

the probability

$${p}_{j}^{I}$$

of the j^{th} intent label given the utterance is computed by using a corresponding weight vector and the sigmoid function, following Equation 8.

In particular, the number [symbol] ^{INP} of intents for the input utterance is computed as:

$${INP}^{} = arg max ( softmax ( {{W}^{INP} ( {V}^{I} )}^{T} {w}^{INP} ) ) ,$$

where W^{INP}∈ [symbol] ^{z×|L}^{^{I}}^{|} and w^{INP}∈ [symbol] ^{d}^{ₑ} are weight matrix and vector, respectively, and z is the maximum number of gold intents for an utterance in the training data. We then select the top [symbol] ^{INP} highest probabilities

$${p}_{j}^{I}$$

and consider their corresponding intent labels as the final intent outputs.

An intent detection object loss [symbol] _{ID} is computed as the sum of the binary cross entropy loss based on the probabilities

$${p}_{j}^{I}$$

for multiple intent prediction and the multi-class cross entropy loss for predicting the number [symbol] ^{INP} of intents.

In Slot decoder, the slot filling task is formulated as a sequence labeling problem based on the BIO scheme. E^{S} (computed as in Equation 3) and [symbol] ₊₂ (computed following Equation 16) are concatenated to create a slot filling-specific matrix H^{S}∈ [symbol] ^{(d}^{ₑ}^{+d)×n} where its i^{th} column vector

$${v}_{i}^{S} ∈ {ℝ}^{{d}_{e} + d}$$

is referred to as the final vector representation of the i^{th} input word with reference to slot filling. Each

$${v}_{i}^{S}$$

is projected into the [symbol] ^{2|} [symbol] ^{|+1} vector space by using a project matrix X^{S}∈ [symbol] ^{(2|} [symbol] ^{|+1)×(d}^{ₑ}^{+d)} to obtain output vector

$${h}_{i}^{s} = {X}^{s} {v}_{i}^{s} .$$

Then the output vectors

$${h}_{i}^{S}$$

are fed into a linear-chain label decoder for slot label prediction.

A cross-entropy loss [symbol] _{SF} is calculated for slot filling during training while the Viterbi algorithm is used for inference.

In joint training, the final training objective loss [symbol] is a weighted sum of the intent detection loss [symbol] _{ID} and the slot filling loss [symbol] _{SF}:

$$ℒ = λ {ℒ}_{ID} + ( 1 - λ ) {ℒ}_{SF} \qquad ( 17 )$$

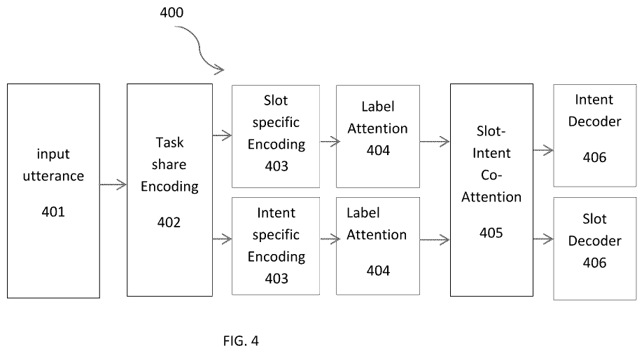

FIG. 4 is a block diagram of a process 400 for automated intent detection and generating of machine-readable dialogue phrases via a slot filling process based on the architecture of the joint model.

The process 400 is described in conjunction with the system 201 of FIG. 2A for illustrative purpose. The process begins as the system 201 receives an input utterance at the Speech Recognition 236 (block 401). The task-shared encoder 240 use the received utterance as inputs and generates feature vectors (embeddings) of the input utterance. At block 402, the two different BiLSTM-based encoders (namely slot-specific encoder and intent-specific encoder) take the task-share feature vectors as inputs and output the slot-specific latent vectors and the intent-specific latent vectors for slot filling and intent detection respectively. The slot-specific latent vectors and the intent-specific latent vectors are enhanced by using label attention mechanism to generate intent and slot label-specific matrix for capturing the characteristics of each intent/slot label for deep understanding and fine-grained information about the semantic nuances associated with different intent and slot labels, which ultimately helps improve the overall results of intent detection and slot filling. In block 405, an intent-slot co-attention mechanism is applied to the intent and slot label-specific matrix to extract the correlations between intent detection and slot filling through multiple intermediate layers of the co-attention component. Finally, the intent decoder and slot decoder are used to predict user intent and slot labels.

The contributions of the invention are summarized as follows: (I) Introducing a novel joint model called MISCA for multiple intent detection and slot filling tasks, which incorporates label attention and intent-slot co-attention mechanisms; (II) MISCA effectively captures correlations between intents and slot labels and facilitates the transfer of correlation information in both the intent-to-slot and slot-to-intent directions through multiple levels of label-specific representations. (III) Experimental results show MISCA outperforms previous strong baselines, achieving new state-of-the-art overall accuracies on two benchmark datasets.

TABLE 1
Obtained results without PLM. The best score is in
bold, while the second best score is in underline.

| | MixATIS | | | MixSNIPS | | |
|---|---|---|---|---|---|---|
| | Intent | Slot | Overall | Intent | Slot | Overall |
| Model | (Acc.) | (F1) | (Acc.) | (Acc.) | (F1) | (Acc.) |
| AGIF (Qin et al., 2020) | 74.4 | 86.7 | 40.8 | 95.1 | 94.2 | 74.2 |
| GL-GIN (Qin et al., 2021) | 76.3 | 88.3 | 43.5 | 95.6 | 94.9 | 75.4 |
| SDJN (Chen et al., 2022a) | 77.1 | 88.2 | 44.6 | 96.5 | 94.4 | 75.7 |
| GISCo (Song et al., 2022) | 75.0 | 88.5 | 48.2 | 95.5 | 95.0 | 75.9 |
| SSRAN (Cheng et al., 2022) | 77.9 | 89.4 | 48.9 | 98.4 | 95.8 | 77.5 |
| Rela-Net (Xing and Tsang, | 78.5 | 90.1 | 52.2 | 97.6 | 94.7 | 76.1 |
| 2022b) | | | | | | |
| Co-guiding (Xing and Tsang, | 79.1 | 89.8 | 51.3 | 97.7 | 95.1 | 77.5 |
| 2022a) | | | | | | |
| MISCA | 76.7 | 90.5 | 53.0 | 97.3 | 95.2 | 77.9 |

1. A method for training of a spoken language understanding (SLU) system comprising:
obtaining, by a task-shared encoder, an input utterance consisting of n word tokens w₁, w₂, . . . , wₙ;
generating, by the task-shared encoder, a vector eᵢ to represent an i^{th} word token wᵢ based on the word tokens w₁, w₂, . . . , wₙ;
generating, by an intent-specific encoder, intent-specific latent vectors
$${e}_{i}^{I}$$
for intent detection based on a sequence of vectors e_{1:n}, wherein the intent-specific latent vectors are concatenated to formulate an intent-specific matrix E^{I};
generating, by a slot-specific encoder, slot-specific latent vectors
$${e}_{i}^{S}$$
for slot filling based on the sequence of vectors e_{1:n}, wherein the slot-specific latent vectors are concatenated to formulate a slot-specific matrix E^{S};
generating, by a slot-specific encoder, an intent label-specific matrix V^{I} based on the intent-specific matrix E^{I};
generating, by the label attention component, slot label-specific matrices V^{S,k} based on the slot-specific matrix E^{S};
generating, by an intent-slot co-attention component, a multiple intent representing matrix [symbol] ₁ based on the slot-specific matrix E^{S}, the intent label-specific matrix V^{I} and the slot label-specific matrices V^{S,k};
generating, by the intent-slot co-attention component, a slot representing matrix [symbol] ₊₂ based on the slot-specific matrix E^{S}, the intent label-specific matrix V^{I} and the slot label-specific matrices V^{S,k};
generating, by a multiple intent decoder, final intent outputs based on the multiple intent representing matrix [symbol] ₁ and the intent label-specific matrix V^{I};
generating, by a slot decoder, final slot output based on the slot representing matrix [symbol] ₊₂ and the slot-specific matrix E^{S};
computing, by the multiple intent decoder, an intent detection loss [symbol] _{ID};
computing, by the slot decoder, a slot filling loss [symbol] _{SF}; and
adjusting the SLU system based on an objective loss [symbol] , wherein the objective loss [symbol] is a weighted sum of the intent detection loss [symbol] _{ID} and the slot filling loss [symbol] _{SF}.

2. The method of claim 1, further comprising:
receiving, by an audio input device, the input utterance; and
generating, by an output device, an output utterance based on the input utterance.

3. The method of claim 2, wherein the generating the vector eᵢ to represent the i^{th} word token wᵢ comprises concatenating a contextual word embedding
$${e}_{i}^{{BiLSTM}_{word}} ,$$
a self-attention embedding
$${e}_{i}^{SA}$$
and a character-level word embedding
$${e}_{{w}_{i}}^{{BiLSTM}_{char .}} ,$$
which is according to the following formula:
$${e}_{i} = {e}_{i}^{BiLSTMword} ⊕ {e}_{i}^{SA} ⊕ {e}_{{w}_{i}}^{BiLSTMchar .} ;$$
wherein:
the contextual word embedding
$${e}_{i}^{{BiLSTM}_{word}}$$
is an embedding or the token word wᵢ, derived by applying a single bidirectional BILSTM layer to real valued embedding representations e_{w}_{₁}, e_{w}_{₂}, . . . , e_{w}_{ₙ},
the self-attention embedding
$${e}_{i}^{SA}$$
is an embedding of word wᵢ, derived by applying a single self-attention layer to the real valued embedding representations e_{w}_{₁}, e_{w}_{₂}, . . . , e_{w}_{ₙ}; and
the character-level word embedding
$${e}_{{w}_{i}}^{{BiLSTM}_{char .}}$$
is a character-level word embedding, derived by applying another single BILSTM (BiLSTM_{char.}) to the real valued embedding representations of characters in each word token wᵢ.

4. The method of claim 3, wherein the generating, by the label attention component, the intent label-specific matrix V^{I} based on the intent-specific matrix E^{I}, comprises:
computing an intent label-specific attention weight matrix A^{I} based on a following formula:
$${A}^{I} = softmax ( {B}^{I} \times tanh ( {D}^{I} \times {E}^{I} ) ) ;$$
wherein the softmax is performed at a row level to make sure that a summation of weights in each row is equal to 1, and B^{I}∈ [symbol] ^{|L}^{^{I}}^{|×d}^{ₐ}, D^{I}∈ [symbol] ^{d}^{ₐ}^{×d}^{ₑ}; and
generating the intent label-specific matrix V^{I} based on the intent-specific matrix E^{I} and the intent label-specific attention weight matrix A^{I}.

5. The method of claim 4, wherein the generating, by the label attention component, the slot label-specific matrices V^{S,k} based on the slot-specific matrix E^{S}, comprises:
computing a slot label-specific attention weight matrix A^{S,k} based on a following formula:
$${A}^{S , k} = softmax ( {B}^{S , k} \times tanh ( {D}^{S , k} \times {E}^{S} ) ) ;$$
wherein the softmax is performed at a row level to make sure that a summation of weights in each row is equal to 1, and B^{S,k}∈ [symbol] ^{|L}^{^{S,k}}^{|×d}^{ₐ}, D^{S,k}∈ [symbol] ^{d}^{ₐ}^{×d}^{ₑ}, in which L^{I} and L^{S,k} are the intent label set and the set of slot label types at the k^{th} hierarchy level, respectively; and
generating the slot label-specific matrices V^{S,k} based on the slot-specific matrix E^{S} and the slot label-specific attention weight matrix A^{S,k}.

6. The method of claim 5, further comprising:
updating the slot label-specific matrix V^{S,k} with a more coarse-grained label information from a (k−1)^{th} hierarchy level.

7. The method of claim 6, wherein the generating, by the intent-slot co-attention component, the multiple intent representing matrix [symbol] ₁ based on the slot-specific matrix E^{S}, the intent label-specific matrix V^{I} and the slot label-specific matrices V^{S,k} comprises:
generating a soft slot label matrix S based on the slot-specific matrix E^{S};
projecting each matrix Qₜ of the soft slot label matrix S, the intent label-specific matrix V^{I} and the slot label-specific matrices V^{S,k} into two spaces to obtain projected matrices [symbol] ₜ and Qₜ;
computing a bilinear attention between a previous matrix Qₜ₋₁ and a current matrix Qₜ to measure a correlation Cₜ between their corresponding label types;
generating the multiple intent representing matrix [symbol] ₁ based on the projected matrices [symbol] ₜ and \vec{Q}ₜ and the correlation Cₜ.

8. The method of claim 7, wherein the generating, by the intent-slot co-attention component, the slot representing matrix [symbol] ₊₂ based on the slot-specific matrix E^{S}, the intent label-specific matrix V^{I} and the slot label-specific matrices V^{S,k} comprises:
generating the soft slot label matrix S based on the slot-specific matrix E^{S};
projecting each matrix Qₜ of the soft slot label matrix S, the intent label-specific matrix V^{I} and the slot label-specific matrices V^{S,k} into two spaces to obtain the projected matrices [symbol] ₜ and Qₜ;
computing a bilinear attention between a previous matrix Qₜ₋₁ and a current matrix Qₜ to measure a correlation Cₜ between their corresponding label types;
generating the slot representing matrix [symbol] ₊₂ based on the projected matrices [symbol] ₜ and \vec{Q}ₜ and the correlation Cₜ.

9. The method of claim 8, wherein the generating, by the multiple intent decoder, the final intent outputs based on the multiple intent representing matrix [symbol] ₁ and the intent label-specific matrix V^{I} comprises:
concatenating the multiple intent representing matrix [symbol] ₁ and the intent label-specific matrix V^{I} to create a final intent label-specific matrix H^{I};
computing a probability
$${p}_{j}^{I}$$
of a j^{th} intent label based on a j^{th} column vector of the final intent label-specific matrix H^{I} by using a corresponding weight vector and a sigmoid function;
predicting a number of intents [symbol] ^{INP} based on the input utterance; and
selecting intent labels with the top highest probabilities
$${p}_{j}^{I}$$
based on the number of intents [symbol] ^{INP} as the final intent outputs.

10. The method of claim 9, wherein the generating, by the slot decoder, the final slot output based on the slot representing matrix [symbol] ₊₂ and the slot-specific matrix E^{S} comprises:
concatenating the slot representing matrix [symbol] ₊₂ and the slot-specific matrix E^{S} to create a final slot filling-specific matrix H^{S};
projecting each column vector
$${v}_{i}^{S}$$
of the final slot filling-specific matrix H^{S} to obtain a projected column vector
$${h}_{i}^{S} ;$$
and
feeding the projected column vectors
$${h}_{i}^{S}$$
into a linear-chain CRF predictor for slot label prediction to obtain the final slot output.

11. A spoken language understanding (SLU) system comprising:
one or more processors; and
a computer-readable medium having instructions stored there on, which, when executed by the one or more processors, cause the system to perform operations comprising:
obtaining an input utterance consisting of n word tokens w₁, w₂, . . . , wₙ;
generating a vector eᵢ to represent an i^{th} word token wᵢ based on the word tokens w₁, w₂, . . . , wₙ;
generating intent-specific latent vectors
$${e}_{i}^{I}$$
for intent detection based on a sequence of vectors e_{1:n}, wherein the intent-specific latent vectors are concatenated to formulate an intent-specific matrix E^{I};
generating slot-specific latent vectors
$${e}_{i}^{S}$$
for slot filling based on the sequence of vectors e_{1:n}, wherein the slot-specific latent vectors are concatenated to formulate a slot-specific matrix E^{S};
generating an intent label-specific matrix V^{I} based on the intent-specific matrix E^{I};
generating slot label-specific matrices V^{S,k} based on the slot-specific matrix E^{S};
generating a multiple intent representing matrix [symbol] ₁ based on the slot-specific matrix E^{S}, the intent label-specific matrix V^{I} and the slot label-specific matrices V^{S,k};
generating a slot representing matrix [symbol] ₊₂ based on the slot-specific matrix E^{S}, the intent label-specific matrix V^{I} and the slot label-specific matrices V^{S,k};
generating a final intent outputs based on the multiple intent representing matrix [symbol] ₁ and the intent label-specific matrix V^{I};
generating final slot output based on the slot representing matrix [symbol] ₊₂ and the slot-specific matrix E^{S};
computing an intent detection loss [symbol] _{ID};
computing a slot filling loss [symbol] _{SF}; and
adjusting the SLU system based on an objective loss [symbol] wherein the objective loss [symbol] is a weighted sum of the intent detection loss [symbol] _{ID} and the slot filling loss [symbol] _{SF}.

12. The system of claim 11, wherein the instructions further cause the system to perform the operations of:
receiving, by an audio input device, the input utterance; and
generating, by an output device, an output utterance based on the input utterance.

13. The system of claim 12, wherein the generating the vector eᵢ to represent the i^{th} word token wᵢ comprises concatenating a contextual word embedding
$${e}_{i}^{{BiLSTM}_{word}} ,$$
a self-attention embedding
$${e}_{i}^{SA}$$
and a character-level word embedding
$${e}_{i}^{{BiLSTM}_{char .}} ,$$
which according to the following formula:
$${e}_{i} = {e}_{i}^{{BiLSTM}_{word}} ⊕ {e}_{i}^{SA} ⊕ {e}_{i}^{{BiLSTM}_{char .}} ;$$
wherein:
the contextual word embedding
$${e}_{i}^{{BiLSTM}_{word}}$$
is an embedding of the token word wᵢ, derived by applying a single bidirectional BILSTM layer to real valued embedding representations e_{w}_{₁}, w₂, . . . , e_{w}_{ₙ};
the self-attention embedding
$${e}_{i}^{SA}$$
is an embedding of word wᵢ, derived by applying a single self-attention layer to the real valued embedding representations e_{w}_{₁},e_{w}_{₂}, . . . , e_{w}_{ₙ}; and
the character-level word embedding
$${e}_{i}^{{BiLSTM}_{char .}}$$
is a character-level word embedding, derived by applying another single BILSTM (BILSTM_{char.}) to the real valued embedding representations of characters in each word token wᵢ.

14. The system of claim 13, wherein the generating the intent label-specific matrix V^{I} based on the intent-specific matrix E^{I}, comprises:
computing an intent label-specific attention weight matrix A^{I} based on a following formula:
$${A}^{I} = softmax ( {B}^{I} \times tanh ( {D}^{I} \times {E}^{I} ) ) ;$$
wherein the softmax is performed at a row level to make sure that a summation of weights in each row is equal to 1, and B^{I}∈ [symbol] ^{|L}^{^{I}}^{|×d}^{ₐ}, D^{I}∈ [symbol] ^{d}^{ₐ}^{×d}^{ₑ}; and
generating the intent label-specific matrix V^{I} based on the intent-specific matrix E^{I} and the intent label-specific attention weight matrix A^{I}.

15. The system of claim 14, wherein the generating the slot label-specific matrices V^{S,k} based on the slot-specific matrix E^{S}, comprises:
computing a slot label-specific attention weight matrix A^{S,k} based on a following formula:
$${A}^{S , k} = softmax ( {B}^{S , k} \times tanh ( {D}^{S , k} \times {E}^{S} ) ) ;$$
wherein the softmax is performed at a row level to make sure that a summation of weights in each row is equal to 1, and B^{S,k}∈ [symbol] ^{|L}^{^{S,k}}^{|×d}^{ₐ}, D^{S,k}∈ [symbol] ^{d}^{ₐ}^{×d}^{ₑ}, in which L^{I} and L^{S,k} are the intent label set and the set of slot label types at the k^{th} hierarchy level, respectively; and
generating the slot label-specific matrices V^{S,k} based on the slot-specific matrix E^{S} and the slot label-specific attention weight matrix A^{S,k}.

16. The system of claim 15, wherein the instructions further cause the system to perform the operations of:
updating the slot label-specific matrix V^{S,k} with a more coarse-grained label information from a (k−1)^{th} hierarchy level.

17. The system of claim 16, wherein the generating the multiple intent representing matrix [symbol] ₁ based on the slot-specific matrix E^{S}, the intent label-specific matrix V^{I} and the slot label-specific matrices V^{S,k} comprises:
generating a soft slot label matrix S based on the slot-specific matrix E^{S};
projecting each matrix Qₜ of the soft slot label matrix S, the intent label-specific matrix V^{I} and the slot label-specific matrices V^{S,k} into two spaces to obtain projected matrices [symbol] ₜ and \vec{Q}ₜ;
computing a bilinear attention between a previous matrix Qₜ₋₁ and a current matrix Qₜ to measure a correlation Cₜ between their corresponding label types;
generating the multiple intent representing matrix [symbol] ₁ based on the projected matrices [symbol] ₜ and \vec{Q}ₜ and the correlation Cₜ.

18. The system of claim 17, wherein the generating the slot representing matrix [symbol] ₊₂ based on the slot-specific matrix E^{S}, the intent label-specific matrix V^{I} and the slot label-specific matrices V^{S,k}, comprises:
generating the soft slot label matrix S based on the slot-specific matrix E^{S};
projecting each matrix Qₜ of the soft slot label matrix S, the intent label-specific matrix V^{I} and the slot label-specific matrices V^{S,k} into two spaces to obtain the projected matrices [symbol] ₜ and \vec{Q}ₜ;
computing a bilinear attention between a previous matrix Qₜ₋₁ and a current matrix Qₜ to measure a correlation Cₜ between their corresponding label types;
generating the slot representing matrix [symbol] ₊₂ based on the projected matrices [symbol] ₜ and \vec{Q}ₜ and the correlation Cₜ.

19. The system of claim 18, wherein the generating the final intent outputs based on the multiple intent representing matrix [symbol] ₁ and the intent label-specific matrix V^{I} comprises:
concatenating the multiple intent representing matrix [symbol] ₁ and the intent label-specific matrix V^{I} to create a final intent label-specific matrix H^{I};
computing a probability
$${p}_{j}^{I}$$
of a j^{th} intent label based on a j^{th} column vector of the final intent label-specific matrix H^{I} by using a corresponding weight vector and a sigmoid function;
predicting a number of intents [symbol] ^{INP} based on the input utterance; and
selecting intent labels with the top highest probabilities
$${p}_{j}^{I}$$
based on the number of intents [symbol] ^{INP} as the final intent outputs.

20. The system of claim 19, wherein the generating the final slot output based on the slot representing matrix [symbol] ₊₂ and the slot-specific matrix E^{S} comprises:
concatenating the slot representing matrix [symbol] ₊₂ and the slot-specific matrix E^{S} to create a final slot filling-specific matrix H^{S};
project each column vector
$${v}_{i}^{S}$$
of the final slot filling-specific matrix H^{S} to obtain a projected column vector
$${h}_{i}^{S} ;$$
and
feeding the projected column vectors
$${h}_{i}^{S}$$
into a linear-chain CRF predictor for slot label prediction to obtain the final slot output.

21. A non-transitory computer-readable storage medium comprising instructions that, when executed by at least one processor of a machine, cause the machine to perform the method of claim 1.
